(19) United States
(12) Patent Application Publication
(10) Pub. No.: US 2006/0187577 A1
(43) Pub. Date: Aug. 24, 2006

(54) Disk drive cover

(75) Inventors: Song Cheh Ser, Singapore (SG); Weng How Leong, Singapore (SG)

Correspondence Address: NIXON & VANDERHYE, PC, 901 NORTH GLEBE ROAD, 11TH FLOOR, ARLINGTON, VA, 22203, US

(73) Assignee: METALFORM ASIA PTE LTD., Singapore (SG)

(21) Appl. No.: 11/341,868

(22) Filed: Jan. 30, 2006

Related U.S. Application Data
(60) Provisional application No. 60/648,278, filed on Jan. 31, 2005.

(51) Int. Cl. G11B 17/00

(52) U.S. Cl. 360/97.01

(57) ABSTRACT

The present invention is directed to a top cover for a hard disk drive. According to one embodiment of the present invention, a top cover for a hard disk drive is fabricated by stamping a steel sheet. The top cover is formed with a surface hardness of at least about 50 HRC. Top covers fabricated according to the present invention have a relatively high surface hardness and stiffness, hence are better able to prevent scratch and resist deflection.

This application claims priority from U.S. Provisional Patent Application No. 60/648,278, filed on Jan. 31, 2005, entitled “Heat Treated High Carbon Steel Material For Hard Disk Drive Applications,” contents of which are hereby incorporated by reference.

### FIELD OF THE INVENTION

The present invention relates to disk drives. In particular, it relates to a hard disk drive cover.

### BACKGROUND OF THE INVENTION

In hard disk drive applications, the disk drive cover is formed with the desired shape and features by stamping a stainless steel sheet or a carbon steel sheet. However, conventional hard disk top covers are easily scratched, and hard disk covers with scratches, even if very minor, are routinely rejected by hard disk drive manufacturers. Further, when secured to the base of the hard disk drive, the top cover is prone to deflection from the pressure caused by a compressed gasket between the base and the top cover. The deflection may cause vibration, resulting in unwanted noise, reducing the acoustic performance and even causing errors during hard disk drive operation. In certain circumstances, the deflection may reduce the sealing effect of the gasket. The hard disk drive is then at risk of being contaminated and this may cause hard disk drive failure.

There is therefore a need to provide an improved top cover and its fabrication method for hard disk drives.

### SUMMARY OF THE INVENTION

The present invention is directed to a top cover for a hard disk drive. According to one embodiment of the present invention, a top cover for a hard disk drive is fabricated by stamping a steel sheet. The top cover is formed with a surface hardness of at least about 50 Hardness Rockwell C (HRC). Top covers fabricated according to the present invention therefore have a relatively high surface hardness and stiffness, hence are better able to prevent scratch and resist deflection.

The present invention is further directed to a method for fabricating a top cover for a disk drive. According to one embodiment of the present invention, a steel sheet is stamped to form a shaped workpiece, which has the same shape and configuration as the top cover. The steel sheet is selected from a material suitable for the stamping process. For example, the steel sheet may be a 0.45% carbon steel with a surface hardness of below about 20 HRC. The workpiece is then heated to a temperature of about 850° C. and maintained at this temperature for a period of time. Depending on the material load, the time period may vary. Thereafter, the workpiece is quenched in an oil bath so that the temperature is reduced to room temperature, i.e. about 25° C. The workpiece is then heated again but to a temperature of about 250° C. and maintained at this temperature for a period of time. Similarly, the time period to maintain the workpiece at 250° C. varies according to the material load of the workpiece. Thereafter, the workpiece is again cooled in an oil bath until it reaches room temperature. A top cover for a hard disk drive is therefore formed, with a surface hardness of about 50 HRC or higher.

A top cover according to the present invention has an increased surface hardness typically from about 20 HRC or below, to about 50 HRC or higher. This results in an increased capability to resist scratching. In addition, the increase of the surface hardness also contributes to a higher level of stiffness and rigidity of the top cover, resulting in an increased capability to resist deflection.

Other aspects and advantages of the present invention will become apparent from the following detailed description, taken in conjunction with the accompanying drawings, illustrating by way of example the inventive concept of the present invention.

### BRIEF DESCRIPTION OF THE DRAWINGS

These and other aspects and advantages of the present invention will be described in detail with reference to the accompanying drawings, in which:

FIG. 1 is a perspective view of a top cover for a hard disk drive according to one embodiment of the present invention;

FIG. 2 is a flow chart showing a method for fabricating a top cover for a hard disk drive according to one embodiment of the present invention.

FIG. 3 is a top view of a top cover for a hard disk drive according to one embodiment of the present invention.

FIG. 4 is a chart showing test results of deflection against load of the top cover shown in FIG. 3.

FIG. 5 is a top view of a top cover for a hard disk drive according to one embodiment of the present invention.

FIG. 6 is a chart showing test results of deflection against load of the top cover shown in FIG. 5.

### DETAILED DESCRIPTION OF THE PREFERED EMBODIMENTS

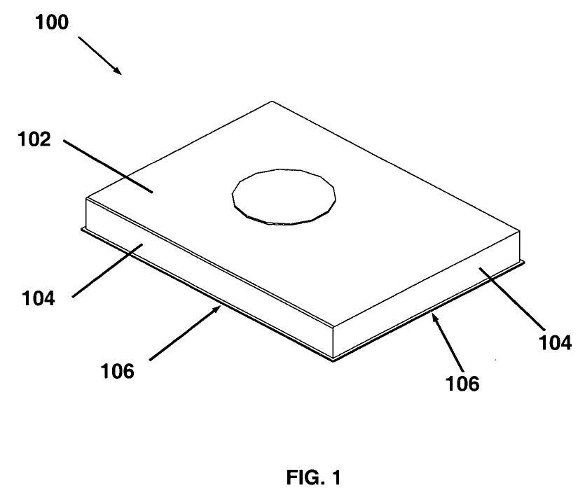

As shown in FIG. 1, a top cover 100 for a 1-inch hard disk drive according to one embodiment of the present invention has a top surface 102 and a surrounding side wall 104 extending perpendicularly from top surface 102. A gasket-sealing ridge 106 is formed on one end of the side wall 104. The top cover 100 is generally rectangular in shape and fabricated by stamping a steel sheet. The top cover 100 has a surface hardness of about 50 HRC or higher. This level of surface hardness is much higher than conventional top covers. A top cover according to the present embodiment therefore has a relatively high capability to resist scratching. In addition, the top cover according to the present embodiment has a relatively higher stiffness and rigidity, hence has an increased capability to resist deflection.

The steel sheet used to stamp-forming the top cover has a thickness of about 0.1 mm to about 1.5 mm, and is made of a material having a carbon content of 0.45% or higher and with a surface hardness of about 20 HRC or lower. The top surface 102 has a flatness of 0.1 mm or lower which is well suited for hard disk drive applications. According to a further embodiment, the gasket-sealing ridge 106 is located within a plane having a flatness of 0.1 mm or lower.

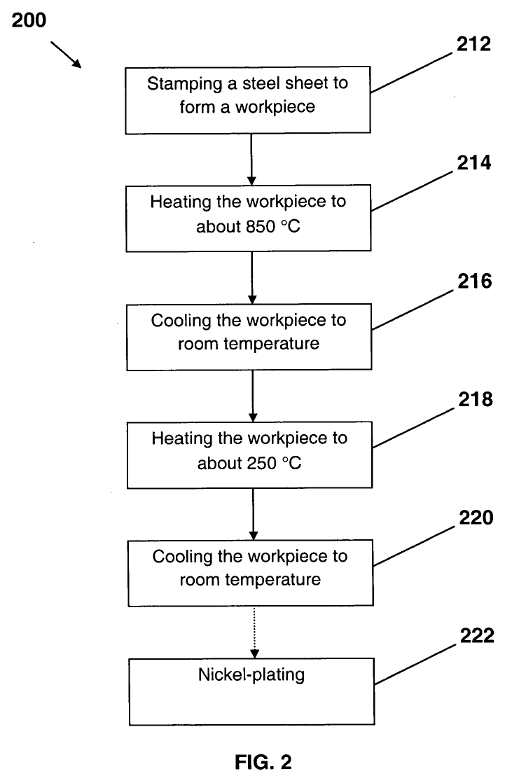

FIG. 2 is a flow chart showing a method 200 for fabricating a top cover for a hard disk drive according to one embodiment of the present invention. In block 212, a steel sheet, such as a 0.2 mm-thick 0.45% carbon steel sheet with a surface hardness of about 20 HRC or below, is stamped to form a workpiece which has the same shape and configuration as the top cover. Thereafter, as shown in block 214, the workpiece is heated to a temperature of about 850° C. and maintained at this temperature for a period of time. Depending on the material load, the time period may vary. For example, when one lot of 600 workpieces of the same shape configurations are heated in one batch, the time period to maintain the lot of 600 workpieces at 850° C. is about 45 minutes

The workpiece is then quenched in an oil bath to quickly cool down to room temperature, i.e. about 25° C., as shown in block 216. Thereafter, the workpiece is heated to a temperature of about 250° C., as shown in block 218, and maintained at this temperature for a period of time. Again the time period varies depending on the material load and/or the hardness vs. temperature requirement.

The workpiece is then cooled down to room temperature to form the top cover, as shown in block 220.

Optionally, the top cover may be plated, for example through electroless nickel plating at about 10 micrometer thickness on the surface of the top cover, to prevent corrosion, as shown in block 222.

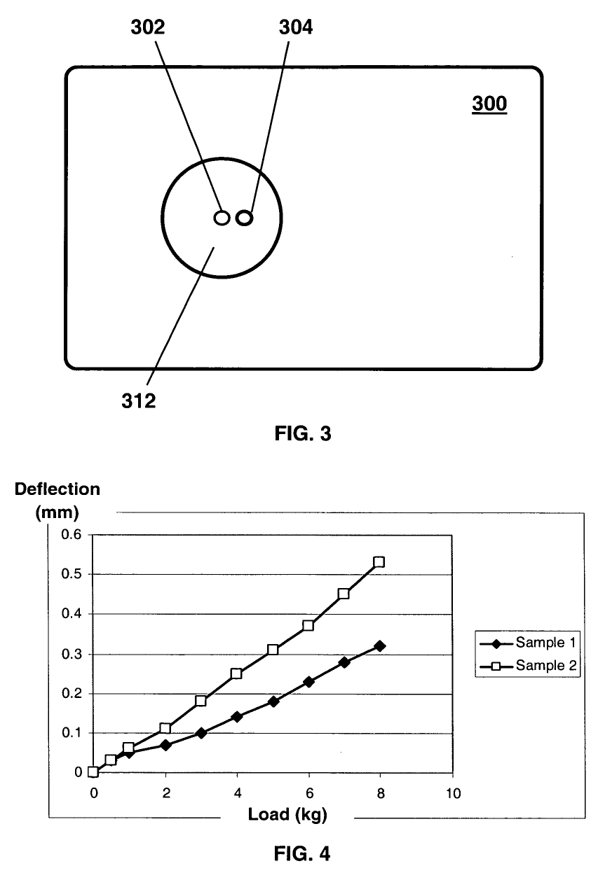

FIG. 3 is a top view of a top cover 300 for a 3.5-inch hard disk drive according to one embodiment of the present invention. A load application point 302, selected within the motor-area 312 and an inspection point 304 within motor-area and adjacent to load application point 302 are designated as shown in FIG. 3. Varies loads ranging from 0 kg to 8 kg are applied at load application point 302, and deflection levels are measured at inspection point 304. Comparison tests are carried out on a conventional hard disk top cover (not shown), made of stainless steel and with the same shape and size configuration. Test data are recorded as shown in Table 1 and illustrated in FIG. 4.

TABLE 1
Deflection level (mm) (sample 1 - present invention top cover;
sample 2 - conventional top cover)

| | Load (kg) | | | | | | | | | |
|---|---|---|---|---|---|---|---|---|---|---|
| | 0 | 0.5 | 1 | 2 | 3 | 4 | 5 | 6 | 7 | 8 |
| Sample 1 | 0 | 0.03 | 0.05 | 0.07 | 0.10 | 0.14 | 0.18 | 0.23 | 0.28 | 0.32 |
| Sample 2 | 0 | 0.03 | 0.06 | 0.11 | 0.18 | 0.25 | 0.31 | 0.37 | 0.45 | 0.53 |

As clearly shown in FIG. 4, a top cover according to the present invention has a lower deflection level than a conventional stainless steel top cover.

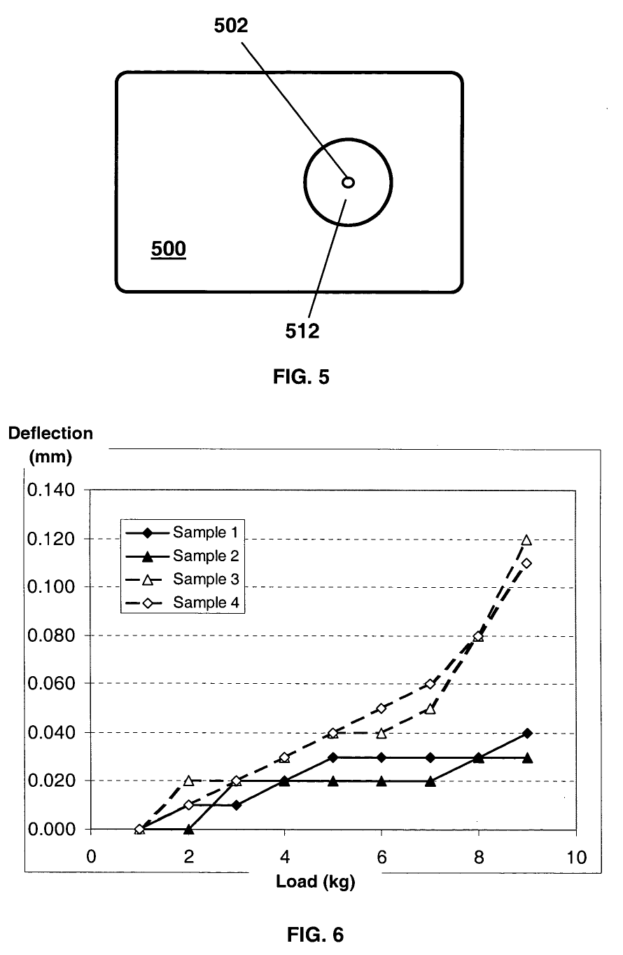

FIG. 5 is a top view of a top cover 500, for a 1-inch hard disk drive according to another embodiment of the present invention. A load application point 502, selected within the motor-area 512 is designated as shown in FIG. 5. Varies loads ranging from 0 kg to 5 kg are applied at load application point 502, and deflection levels are measures at same load application point 502. Comparison tests are carried out on a conventional hard disk top cover (not shown). The conventional top cover is made of carbon steel, and has a surface hardness of about 20 HRC or below, and with the same shape and size configuration. Test data are recorded as shown in Table 2 and illustrated in FIG. 6.

As clearly shown in FIG. 6, a top cover according to the present invention has a deflection level lower than a conventional top cover in the 1-inch hard disk drive application.

TABLE 2
Deflection level (mm) (samples 1 and 2 - present invention
top cover; samples 3 and 4 - conventional top cover)

| | 0 | 0.5 KG | 1.0 KG | 1.5 KG | 2.0 KG | 2.5 KG | 3.0 KG | 4 KG | 5 KG |
|---|---|---|---|---|---|---|---|---|---|
| Sample 1 | 0.000 | 0.010 | 0.010 | 0.020 | 0.030 | 0.030 | 0.030 | 0.030 | 0.040 |
| Sample 2 | 0.000 | 0.000 | 0.020 | 0.020 | 0.020 | 0.020 | 0.020 | 0.030 | 0.030 |
| Sample 3 | 0.000 | 0.020 | 0.020 | 0.030 | 0.040 | 0.040 | 0.050 | 0.080 | 0.120 |
| Sample 4 | 0.000 | 0.010 | 0.020 | 0.030 | 0.040 | 0.050 | 0.060 | 0.080 | 0.110 |

A top cover according to embodiments of the present invention has many advantages over a conventional hard disk drive top cover. Stamping a low-hardness carbon steel sheet, the advantages of high production throughput of stamping process is retained. It should be appreciated to a person skilled in the art, however, that stamped parts are not usually subject to heat-treatment to increase surface hardness. It is therefore not obvious to a person skilled in the art to heat-treating a stamped workpiece, hence hard disc drive top covers available so far remain at a low level of surface hardness and are easily scratched and deflected. The present invention creatively extends the heat-treatment technology to stamped thin-sheet parts, in disk drive manufacturing technologies, and successfully increased the surface hardness of the stamped workpieces. The capabilities of anti-scratching, deflection-resistance of hard disk drive covers are greatly improved. The risk of gasket-sealing leakage is greatly reduced. According to embodiments of the present invention, a top cover for a hard disk drive is fabricated with greatly improved surface hardness and rigidity than conventional top covers, without compromising other physical properties required for hard disk drive applications. For example, the flatness of the top cover for a 1-inch hard disk drive is maintained at a level of 0.1 mm or below.

Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. A top cover for a disk drive, wherein the top cover is stamped from a steel sheet and wherein the top cover has a surface hardness of at least about 50 HRC.

2. The top cover as recited in claim 1, wherein the steel sheet has a thickness of about 0.1 mm to about 1.5 mm.

3. The top cover as recited in claim 1, wherein the steel sheet is made of a material having a carbon content of at least about 0.45 wt %.

4. The top cover as recited in claim 1 having a top surface, wherein the top surface has a flatness of not more than about 0.1 mm.

5. The top cover as recited in claim 1 having a gasket-attachment portion, wherein the gasket-attachment portion is located in a plane having a flatness of not more than about 0.1 mm.

6. The top cover as recited in claim 1, further comprising a nickel layer plated thereon.

7. A top cover for a disk drive, wherein the top cover is fabricated by a method comprising:
stamping a steel sheet to form a shaped workpiece;
heating the shaped workpiece to a first temperature of about 850° C.;
cooling the shaped workpiece to room temperature;
heating the shaped workpiece to a second temperature of about 250° C.; and
cooling the shaped workpiece to room temperature.

8. The top cover as recited in claim 7 having a surface hardness of at least about 50 HRC.

9. The top cover as recited in claim 7 having a top surface, wherein the top surface has a flatness of not more than about 0.1 mm.

10. The top cover as recited in claim 7, wherein the steel sheet has a thickness of about 0.1 mm to about 1.5 mm.

11. The top cover as recited in claim 7, wherein the steel sheet has a carbon content of at least about 0.45 wt %.

12. The top cover as recited in claim 7, further comprising a nickel layer plated thereon.

13. A method for fabricating a top cover of a disk drive, comprising:
stamping a steel sheet to form a shaped workpiece, wherein the steel sheet has a surface hardness of about 20 HRC or lower,
heat-treating the shaped workpiece to form the top cover having a surface hardness higher than that of the steel sheet.

14. The method as recited in claim 13, wherein heat-treating the shaped workpiece comprising:
heating the shaped workpiece to a first temperature of about 850° C.;
cooling the shaped workpiece to room temperature;
heating the shaped workpiece to a second temperature of about 250° C.; and
cooling the shaped workpiece to room temperature.

15. The method as recited in claim 13, wherein the top cover has a surface hardness of at least about 50 HRC.

16. The method as recited in claim 13, wherein the shaped workpiece has a thickness of about 0.1 mm to about 1.5 mm.

17. The method as recited in claim 13, wherein the steel sheet has a carbon content of at least about 0.45 wt %.

18. The method as recited in claim 13, wherein the method further comprises plating the top cover by electroless nickel plating.
